(19) United States
(12) Patent Application Publication
(10) Pub. No.: US 2003/0134980 A1
(43) Pub. Date: Jul. 17, 2003

(54) Polyamide composition for molding

(76) Inventors: Ryuichi Hayashi, Tokyo (JP); Reiko Koshida, Tochigi (JP); Narumi Une, Tochigi (JP); Shiego Ishizuka, Shizuoka (JP); Tomoo Tanaka, Shizuoka (JP)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/308,783

(22) Filed: Dec. 3, 2002

Related U.S. Application Data
(63) Continuation of application No. 09/807,247, filed on Apr. 9, 2001, now abandoned.

(30) Foreign Application Priority Data
Oct. 23, 1998 (JP) 10-302833

(51) Int. Cl. C08F 8/30

(52) U.S. Cl. 525/178

(57) ABSTRACT

A polyamide composition for molded products having thin-wall parts and for connectors for use in automobiles, containing:

A. 100 wt parts of a semi-aromatic polyamide having a melting point of 280 to 320° C. and a glass transition temperature of 95 to 115° C., wherein the amount of aromatic monomer constituting the polyamide is at least 30 mol %, and

B. B. 1 to 70 wt parts of an impact resistance agent composed mainly of a modified polyolefin that has been graft-modified by means of a carboxylic acid or a carboxylic anhydride.

### FIELD OF THE INVENTION

The present invention relates to a polyamide composition that is used as a forming material in molded products having a thin-wall part and electrical connectors for automobiles, more specifically, a polyamide composition that is used as a forming material in molded products having a thin-wall part and electrical connectors for automobiles, said composition having a high tenacity and excellent rigidity in high-temperature, high-humidity environments, chemical resistance, and surface appearance.

### BACKGROUND OF THE INVENTION

High-performance physical properties, stable dimensions, heat resistance, and chemical resistance are required in electrical and electronic parts and automotive parts the used under harsh conditions, particularly parts are used in environments close the engine area.

Such parts are being designed so the part dimensions become smaller and thinner while the original functions are maintained, and a high level of dimensional stability and high productivity for parts is required in order to realize high reliability and low cost.

Engineering plastics are ideal for use as materials in the production of such parts, and their use is becoming widespread. Examples of these uses include thin-wall electric and electronic parts for motor insulators, coil bobbins, etc., precision gear parts, bearing retainers, retainer housings, etc., having thin-wall parts. Parts that are used under high temperatures and high humidity, for example, grips, bands, and snap fittings the used in automobile engine compartments, various sealing materials, housing materials, etc., can also be cited. Since the use of such engineering plastics is in most cases by formation of the part by injection molding, dimensional stability during the injection molding process and productivity, along with the basic physical properties of the materials, are important.

Moreover, electrical connectors for automobiles differ from electrical connectors used in electrical and electronic appliances: since their assembly processes are especially complex, they have numerous parts, and also, since the parts are often shipped during processing, a high degree of rigidity is required. Moreover, since the engine compartment reaches extremely high temperatures, high-temperature rigidity is required in electrical connectors for automobiles, and in addition, automobile parts containing electrical connectors must be able to withstand various climates and be able to handle changes in temperature and changes in humidity. Furthermore, since various chemical products such as engine oils, long-life coolants (LLC), battery liquids, window washing fluids, etc., are used in engine compartments, the electrical connectors must also have good chemical resistance. Thus, the various characteristics required in electrical connectors for automobiles are different from those required in electrical connectors for other electrical and electronic parts.

Semi-aromatic polyamides containing an aromatic monomer constituent in a portion of the constituent elements have been widely used as engineering plastics in injection molding materials having high high-temperature rigidity, chemical resistance, and humidity-resistant stability. Semi-aromatic polyamide compositions are used as molding materials for electric connectors in automobiles.

Semi-aromatic polyamides are known to be polyamides having a higher glass transition temperature and superior high-temperature rigidity, as well as a lower reduction in mechanical characteristics due to water absorption rigidity, in comparison with aliphatic polyamides.

In order to manifest these excellent qualities in these semi-aromatic polyamides, they are injection-molded at comparatively high (approximately 100 to approximately 150° C.) mold temperatures. When the mold temperature is low, sufficient crystallization of the polyamide on the molded product surface cannot be expected, and after molding, surface sink marks, dimensional fluctuation, and deterioration of physical properties can occur. Such problems are conspicuous in molded products having thin-wall parts.

Semi-aromatic polyamides that can be molded at comparatively low mold temperatures (approximately 80 to approximately 100° C.) exist, and in some cases these are used in molded products having thin-wall parts, but in these cases a reduction in high-temperature rigidity, chemical resistance, and particularly humidity resistance has been unavoidable.

On the other hand, in many cases electrical connectors used in automobiles are multipolar and require partition walls in order to prevent conduction between the poles. Therefore they often have both complex forms and thin-wall parts at the same time, due to requirements for miniaturization, and from the standpoint of ease of molding as well, it is required that these molding materials have good fluidity and mold separation properties. Nevertheless, due to their high melting point and viscosity, semi-aromatic polyamides have the defect of being difficult to mold.

In order to improve the moldability of semi-aromatic polyamides, the use of blends of semi-aromatic polyamides and aliphatic polyamides is known (JP 7-216223) is known, and excellent electrical connectors for automobiles have been obtained from such resin blends, but further improvement has been desired with regard to rigidity in moisture absorption.

The object of the present invention is to offer a polyamide resin composition having good moldability when used in the molding of parts having thin-wall portions, little surface roughness, dimensional fluctuation, or deterioration of physical properties after molding, as well as the characteristically high high-temperature rigidity, chemical resistance, and humidity resistance of semi-aromatic polyamides and a polyamide composition that is able to offer electrical connectors for automobiles.

### SUMMARY OF THE INVENTION

A polyamide composition for molded products having thin-wall parts, characterized as containing:

A. 100 wt parts of a semi-aromatic polyamide having a melting point of 280 to 320° C. and a glass transition temperature of 95 to 115° C., and wherein aromatic monomers constituting the polyamide make up at least 30 mol %, and

B. 1 to 70 wt parts of an impact resistance agent composed mainly of a modified polyolefin that has been graft-modified by means of a carboxylic acid or a carboxylic anhydride.

### BRIEF DESCRIPTION OF THE DRAWINGS

FIG. 1 is a diagonal-view diagram of the housing of a male-type electrical connector for automobiles using a composition of the present invention.

FIG. 2 is a diagram showing a cross-section of an electrical connector for automobiles using a composition the present invention.

### DETAILED DESCRIPTION

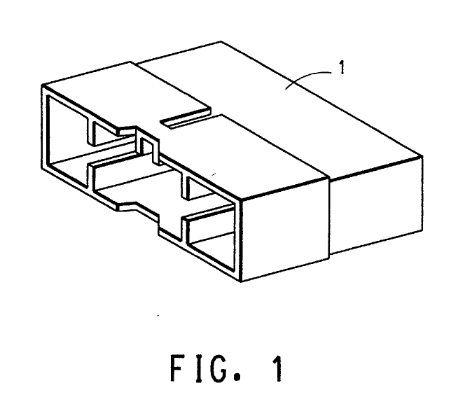

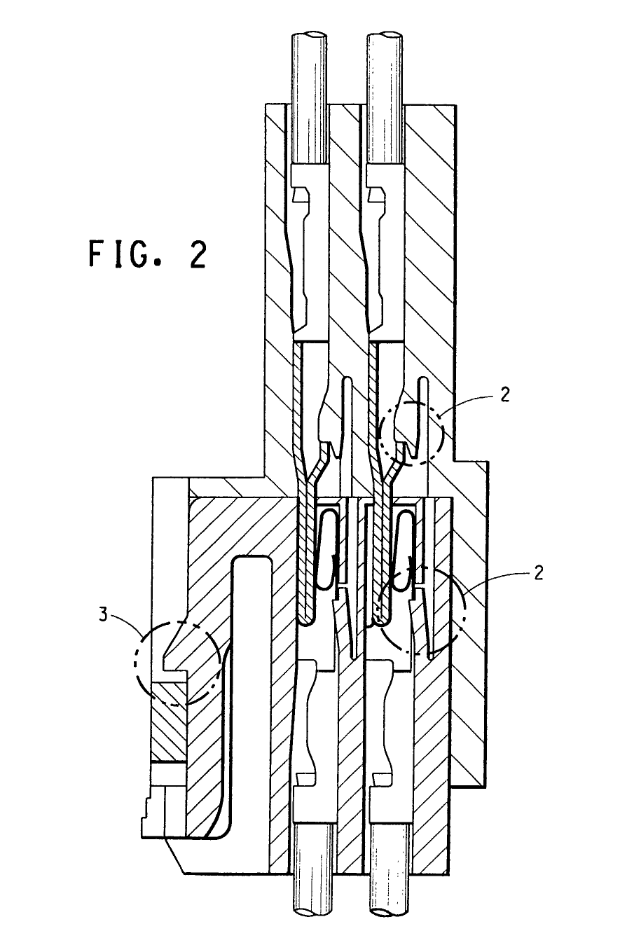

In FIGS. 1 and 2, the parts therein have the following designations

1 male-type housing

2 interlocking parts of housing and terminal

3 interlocking parts of mail-type housing and female-type housing

By selecting constituent materials and constituent ratios having the melting point and glass transition temperature of the semi-aromatic polyamide as a target in polyamide compositions containing certain types of semi-aromatic polyamides and impact resistance agents having a modified polyolefin as a main ingredient, it is possible to offer a polyamide composition that is an ideal molding material for molded parts having thin-wall parts and a polyamide composition that is an ideal molding material for electrical connectors used in automobiles.

Specifically, the polyamide composition for molding molded products having thin-wall parts in accordance with the first mode of the present invention is characterized as containing: A. 100 wt parts of a semi-aromatic polyamide having a melting point of 280 to 320° C. and having a glass transition temperature of 95 to 115° C., wherein the amount of aromatic monomer constituting the polyamide is at least 30 mol %, and B. 1 to 70 wt parts of an impact resistance agent composed mainly of a modified polyolefin that has been graft-modified by means of a carboxylic acid or a carboxylic anhydride.

The polyamide composition for molding molded products having thin-wall parts in accordance with the second of mode of the present invention is characterized as containing: A. 100 wt parts of an aromatic polyamide having a melting point of 280 to 320° C. and glass transition temperature of 95 to 115° C., and wherein the amount of aromatic monomer constituting the polyamide is at least 30 mol %, and the dicarboxylic acid constituent is selected from the group consisting of terephthalic acid, blends of terephthalic acid and isophthalic acid wherein the isophthalic acid in the dicarboxylic acid constituent is no more than 40 mol %, blends of terephthalic acid and adipic acid, and blends of terephthalic acid, isophthalic acid, and adipic acid, wherein the total amount of isophthalic acid and adipic acid in the dicarboxylic acid constituent is no greater than 40 mol %, and the diamine constituent is selected from the group consisting of hexamethylenediamine and blends of hexamethylenediamine and 2-methylpentamethylene, and B. 1 to 70 wt parts of an impact resistance agent composed mainly of a modified polyolefin that has been graft-modified by means of a carboxylic acid or a carboxylic anhydride.

The polyamide composition for molding electrical connectors used in automobiles in accordance with the third mode of the present invention is characterized as containing: A. 100 wt parts of a semi-aromatic polyamide having a melting point of 280 to 320° C. and a glass transition temperature of 95 to 115° C., and wherein the amount of aromatic monomer constituting the polyamide is at least 30 mol %, and B. 1 to 70 wt parts of an impact resistance agent composed mainly of a modified polyolefin that has been graft-modified by means of a carboxylic acid or a carboxylic anhydride.

The polyamide composition for molding electrical connectors used in automobiles in accordance with the fourth mode of the present invention is characterized as containing: A. 100 wt parts of an aromatic polyamide having a melting point of 280 to 320° C. and glass transition temperature of 95 to 115° C., and wherein the amount of aromatic monomer constituting the polyamide is at least 30 mol %, and the dicarboxylic acid constituent is selected from the group consisting of terephthalic acid, blends of terephthalic acid and isophthalic acid wherein the isophthalic acid in the dicarboxylic acid constituent is no more than 40 mol %, blends of terephthalic acid and adipic acid, and blends of terephthalic acid, isophthalic acid, and adipic acid, wherein the total amount of isophthalic acid and adipic acid in the dicarboxylic acid constituent is no greater than 40 mol %, and the diamine constituent is selected from the group consisting of hexamethylenediamine and blends of hexamethylenediamine and 2-methylpentamethylene, and B. 1 to 70 wt parts of an impact resistance agent composed mainly of a modified polyolefin that has been graft-modified by means of a carboxylic acid or a carboxylic anhydride.

Molded products having thin-wall parts obtained by the molding of a polyamide composition within the range specified in the present invention have dimensional fluctuation or deterioration of physical properties, etc., are also provided with the high high-temperature rigidity, chemical resistance, and humidity resistance that is characteristic of semi-aromatic polyamides, and have characteristics optimally suited to use in motor insulators, coil bobbins, precision gear parts, bearing retainers, retainer housings, grips, bands, and snap fittings as well as for use in sealing materials or housings.

Moreover, electrical connectors for use in automobiles obtained by the molding of a polyamide composition within the range specified in the present invention of a retention of terminal holding power when the moisture has been absorbed, low deformation under high-temperature loads, and other properties ideal for use in electrical connector molded products for automobiles.

The polyamide compositions suitable for use in the molding of molded products having thin-wall parts and the polyamide compositions suitable for use in the molding of electrical connectors for automobiles are compositions that contain: A. 100 wt parts of a semi-aromatic polyamide having a melting point of 280 to 320° C., and having a glass transition temperature of 95 to 115° C., wherein the amount of aromatic monomer constituting the polyamide is at least 30 mol %, and B. 1 to 70 wt parts of an impact resistance agent composed mainly of a modified polyolefin that has been graft-modified by means of a carboxylic acid or a carboxylic anhydride.

By selecting the constituent ingredients and constituent ratio of the semi-aromatic polyamide targeting the melting point and glass transition temperature, is possible to form molded products having thin-wall parts with little dimensional fluctuation or reduction of physical properties and having the high high-temperature rigidity, chemical resistance, and moisture resistance characteristic of semi-aromatic polyamides. In particular, it is possible to mold electrical connectors for automobiles having a terminal holding power retention rate of 75% or more when moisture is absorbed, and a maximum deformation under high-temperature loads of 1 mm or less.

The aromatic monomer in the monomer constituents that constitute the polyamide must be contained in an amount of at least 30 mol %, preferably at least 32 mol %, and more preferably at least 32 mol % and no more than 40 mol %. If the aromatic monomer content is less than 30 mol %, the high-temperature rigidity and mechanical characteristics when moisture has been absorbed are impaired.

Specific examples of aromatic monomers include aromatic diamines, aromatic carboxylic acids, and aromatic aminocarboxylic acids. Examples of aromatic diamines include para-phenylenediamine, ortho-phenylenediamine, meta-phenylenediamine, para-xylenediamine, ortho-xylenediamine, meta-xylenediamine, etc., examples of aromatic dicarboxylic acids include terephthalic acid, isophthalic acid, phthalic acid, 2-methylterephthalic acid, naphthalenedicarboxylic acid, etc., and examples of aromatic aminocarboxylic acids include para-aminobenzoic acid, etc., and these aromatic monomers can be used alone or in combinations of two or more. Among these, the use of a terephthalic acid or a mixture of terephthalic acid and isophthalic acid is desirable.

The other constituent ingredients of the semi-aromatic polyamide include aliphatic dicarboxylic acids, aliphatic alkylenediamines, alicyclic alkylenediamines, aliphatic aminocarboxylic acids, etc.

Examples of aliphatic dicarboxylic acid components include adipic acid, sebacic acid, azelaic acid, dodecanoic diacid, etc., and these may be used alone or in combinations of two or more. The use of adipic acid is especially suitable.

The aliphatic alkylenediamine constituent may have a linear or branched form. Specifically, ethylenediamine, trimethylenediamine, tetramethylenediamine, pentamethylenediamine, hexamethylenediamine, 1,7-diaminoheptane, 1,8-diaminooctane, 1,9-diaminononane, 1,10-diaminodecane, 2-methylpentamethyldiamine, 2-ethyltetramethylene diamine, etc., and cited, and these may be used alone or in blends of two or more.

As the alicyclic alkylenediamine component, 1,3-diaminocyclohexane, 1,4-diaminocyclohexane, 1,3-bis(aminomethyl)cyclohexane, bis(aminomethyl)cyclohexane, bis(4-aminocyclohexyl)methane, 4,4′-diamino-3,3′-dimethyldicyclohexylmethane, isophoronediamine, piperazine, etc., can be cited, and these can be used alone or in combinations of two or more.

As the aliphatic aminocarboxylic acid constituent, 6-aminocaproic acid, 11-aminoundecanoic acid, 12-aminododecanoic acid, etc., can be cited, and the corresponding cyclic lactams can be used as the source materials thereof. These too can be used alone or in combinations of two or more.

The specific constituent elements and constituent ratios of the semi-aromatic polyamides wherein aromatic monomers pickup at least 30 mol % of the monomer constituents constituting the polyamide are set so that the melting point of the semi-aromatic polyamide is the range of 280° C. to 320° C. and glass transition temperature is 95° C. to 115° C. Furthermore, by setting the specific constituent elements and constituent ratios of the semi-aromatic polyamides among the aforesaid source material polymers, the desired polyamide composition in which the retention of terminal holding force of the electrical connector when moisture has been absorbed is 75% or above, and the deformation under high-temperature load is 1 mm or less.

Here, the terminal holding power is an index the rigidity and is the load weight (N) required to pull the terminal out of the anchoring part of the housing when the wiring is drawn in the axial direction at a fixed speed of approximately 100 mm/min, when a terminal formed by the pressure-bonding of electric wire having length of approximately 100 mm is fixed in a housing as shown in FIG. 2 in an atmosphere of 23±2° C., humidity 50±5%.

The terminal retention when moisture is absorbed is an index of rigidity when moisture has been absorbed and is the value, represented as percent, of the terminal retention force as measured by means of the same test method using an electrical connector housing that has undergone a moisture absorption treatment (standing for 100 to 200 hours in the environment of 30 to 40° C. temperature, 95% relative humidity) versus the initial terminal holding force.

When the retention of the terminal holding force when moisture is absorbed is less than 75%, separation of the terminal occurs when moisture is absorbed. The retention of the terminal holding force when moisture is absorbed should be at least 85%.

Additionally, the high-temperature load deformation is an index of high-temperature rigidity, and is a value of the amount of deformation of the hood part measured when the load of 50 grams is placed on the male housing hood of electrical connector in an atmosphere having a temperature of 23±2° C. and humidity of 50±5%, when it is allowed to stand for 1 hr at 150° C., the load is then removed, and the hood then allowed to stand in an atmosphere of 23±2° C. and a relative humidity of 50±5% for 15 min.

It is not desirable if the high-temperature load deformation is greater than 1 mm, since the repeated checking and verification at high temperatures becomes impossible. The high-temperature load deformation preferably should be 0.7 mm or less.

The impact resistance agent has as its main constituent a modified polyolefin that has been graft-modified by means of a carboxylic acid or a carboxylic acid anhydride, but may also contain other elastomers. As impact resistance agents having as their main component a modified polyolefin that has been graft-modified by means of a carboxylic acid or a carboxylic acid anhydride, specifically, ethylene elastomers composed of ethylene.alpha-olefins, elastomers composed of ethylene.propylene.diene, olefins such as polyethylene and polypropylene, and ionomers of copolymers and polyolefin copolymers thereof can be cited.

The ethylene elastomers composed of ethylene.alpha-olefins include, for example, ethylene.propylene, ethylene.methylpentene, ethylene.octene copolymers, etc.

Elastomers of the ethylene.propylene.diene type include, for example, ethylene/propylene/1,4-hexadiene-g-maleic anhydride; blends of ethylene/propylene/1,4-hexadiene and ethylene/maleic anhydride; blends of ethylene/propylene/1,4-hexadiene and ethylene/propylene/1,4-hexadiene-g-maleic anhydride; ethylene/propylene/1,4-hexadiene/norbornadiene-g-maleic anhydride fumaric acid; ethylene/1,4-hexadiene/norbomadiene-g-maleic anhydride monoethyl ether; ethylene/propylene/1,4-hexadiene/norbonadiene-g-fumaric acid; blends of ethylene/propylene/1,4-hexadiene and ethylene/maleic anhydride monoethyl ether; blends of ethylene/propylene/1,4-hexadiene and ethylene/monobutyl maleate; blends of ethylene/propylene/1,4-hexadiene and ethylene/maleic anhydride, etc. lonomers of polyolefin copolymers include, for example, ionomers composed of ethylene units, derivative units of alpha- and beta-ethylenically unsaturated carboxylic acids, and ester units, more specifically, ionomers in which the derivative units of alpha- and beta-ethylenically unsaturated carboxylic acids are derivatives of one or more alpha- and beta-ethylenically unsaturated carboxylic acids which are alpha- and beta-ethylenically unsaturated carboxylic acids having a carbon number of 3 to 8, selected from the group consisting of monocarboxylic acids having carboxylic acid groups that have been ionized by neutralization with metal ions, and dicarboxylic acids having carboxylic acid groups and ester groups that have been ionized by neutralization with metal ions, and in which the ester units are acrylates or methacrylates having a carbon number of 4 to 22.

The impact resistance agent may be used alone or in blends of two or more.

The amount of impact resistance agent contained in the polyamide composition of the present invention is 1 to 70 wt parts per 100 wt parts of semi-aromatic polyamide. If the amount is less than 1 weight part, the tenacity required in molded products having thin-wall parts and in electrical connectors for automobiles cannot be obtained, and the amount exceeds 70 wt parts, the high-temperature rigidity required in molded products having thin-wall parts and in electrical connectors for automobiles cannot be obtained. Preferably, this amount should be in a range of 5 to 35 wt parts, more preferably, 10 to 25 wt parts.

If the melting point is lower than 280° C., the heat resistance as molded products having thin-wall parts and electrical connectors for automobiles becomes insufficient, while if it exceeds 320° C., decomposition gas is generated from the composition during molding. Preferably the melting point should be in a range of 295° C. to 310° C.

Additionally, if the glass transition temperature is less than 95° C., the high-temperature, high-humidity rigidity is insufficient for molded products having thin-wall parts and electrical connectors for automobiles, and problems such as part deformation occur. On the other hand, if it exceeds 115° C., when molding conditions normally used for the molding of molded products having thin-wall parts and electrical connectors for automobiles are used, the crystallization of the materials when the resin is cooled in the thin-wall parts is not completed sufficiently. When these areas are subsequently exposed to high temperatures, after-crystallization occurs, and deformation of the parts or sink marks in the surface can occur, causing impairment of appearance. The part dimensions can also be changed by after-crystallization. Additionally, mold separation failure occurs when the part formed is complex and the molded temperature is close to the glass transition temperature of the material.

In order to complete crystallization, the molded temperature can be made higher or the cooling time can be made longer, but this impairs productivity and increases the cost of the molded product.

In order to produce with high efficiency high-performance molded products having thin-wall parts for applications such as motor insulators, coil bobbins, precision gear parts, bearing retainers, retainer housings, grips, bands, and snap fittings as well as for sealing material, housings, etc., it is important to use a semi-aromatic polyamide resin having a glass transition temperature in a range of 95° C. to 115° C., preferably 95° C. to 110° C.

Here, the term “thin-wall part” generally means approximately 3 mm or less, but in parts having a thickness of 2 mm or less, the effect of using the semi-aromatic polyamide resin specified in the present invention is especially striking.

Since electrical connectors for using automobiles have numerous complex thin-wall parts in their form, the following problems occur. Specifically, when the speed crystallization is slow, crystallization is insufficient, and when the temperature is raised further, deformation due to after-crystallization occurs in the thin-wall parts, the rate of crystallization after molding in complex forms is slow, sink marks are formed on the surface, the surface appearance of the molded product is impaired, and with complex forms in combination with thin-wall parts, due to the increase in the adhesive properties between the molded surface and the resin, mold separation properties are impaired.

The glass transition temperature is a value that is measured by means of a dynamic viscoelasticity analyzer (DMA) using a 3.2 mm×13 mm×130 mm test piece used in ASTM D790(-92).

Polyamide compositions which are even more desirable for use in the forming of molded products having thin-wall parts and electrical connectors for automobiles should contain: A. 100 weight parts of an aromatic polyamide having a melting point of 280 to 320° C. and glass transition temperature of 95 to 115° C., and wherein the amount of aromatic monomer constituting the polyamide is at least 30 mol %, and the dicarboxylic acid constituent is selected from the group consisting of terephthalic acid, blends of terephthalic acid and isophthalic acid wherein the isophthalic acid in the dicarboxylic acid constituent is no more than 40 mol %, blends of terephthalic acid and adipic acid, and blends of terephthalic acid, isophthalic acid, and adipic acid, wherein the total amount of isophthalic acid and adipic acid in the dicarboxylic acid constituent is no greater than 40 mol %, and the diamine constituent is selected from the group consisting of hexamethylenediamine and blends of hexamethylenediamine and 2-methylpentamethylene, and B. 1 to 70 weight parts of an impact resistance agent composed mainly of a modified polyolefin that has been graft-modified by means of a carboxylic acid or a carboxylic anhydride. Is desirable that dicarboxylic acid constituents other than terephthalic acid comprise no more than 30 mol %.

The amount of impact resistance agent in the polyamide composition of the present invention is 1 to 70 weight parts. If the amount is less than 1 weight part, the tenacity required in molded products having thin-wall parts and electrical connectors for automobiles cannot be obtained, while if it exceeds 70 weight parts, the high-temperature rigidity required in molded products having thin-wall parts and electrical connectors for automobiles cannot be obtained. This amount should be preferably in a range of 5 to 35 weight parts, even more preferably 10 to 25 weight parts.

It is further desirable that the polyamide composition of the present invention contain a thermal stabilizer. Among the thermal stabilizers, compounds containing copper are desirable, and copper halides such as copper iodide and copper bromide are especially desirable. Normally these can be added in amounts so that the copper content in the polyamide composition is 10 to 1000 ppm. Normally, alkyl halogen compounds are also added as thermal stabilizing assistants.

Moreover, phenolic antioxidants can also be added to the polyamide composition of the present invention. The antioxidant and thermal stabilizer can be used in combination.

Examples of phenolic antioxidants include triethylene glycol.bis[3-(3-t-butyl-5-methyl-4-hydroxyphenyl) propionate], 1,6-hexanediol.bis[3-[3,5-di-t-butyl-4-hydroxyphenyl) propionate], pentaerythrityl-tetrakis[3-(3,5-di-t-butyl-4-hydroxyphenyl) propionate], octadecyl-3-(3,5-di-t-butyl-4-hydroxyphenyl) propionate, 3,5-di-t-butyl-4-hydroxybenzyl phosphonate-diethyl ester, N,N′-hexamethylenebis(3,5-di-t-butyl-4-hydroxy-hydrocinnamide), 1,3,5-trimethyl-2,4,6-tris(3,5-di-t-butyl-4-hydroxybenzyl) benzene, 3,9-bis[2-{3-(3-t-butyl-4-hydroxy-5-methylphenyl)propionyloxy}-1,1-dimethylethyl]-2,4,8,10-tetraoxaspiro [5,5]undecane, etc., and among these pentaerythrityl.tetrakis[3-(3,5-di-t-butyl-4-hydroxyphenyl) propionate] and N,N′-hexamethylenebis(3,5-di-t-butyl-4-hydroxy-hydrocinnamide) are preferable.

Along with phenolic [anti]oxidants, phosphorus-based or sulfur-based antioxidation assistants may also be added. Examples of phosphorus-based or sulfur-based antioxidation assistants include tris(2,4-di-t-butylphenyl) phosphite, 2-[[2,4,8,10-tetrakis(1,1-dimethylethyl)dibenzo[d,f] [1,3 ,2]dioxaphosphepin-6-yl]oxy]-N,N-bis[2-[[2,4,8,10-tetrakis(1,1-dimethylethyl)dibenzo[d,f] [1,3,2]dioxaphosphepin-6-yl]oxy]-ethyl]etamine, bis(2,6-di-t-butyl-4-methylphenyl)pentaerythritol diphosphite, etc., and among these 2-[[2,4,8,10-tetrakis(1,1-dimethylethyl)dibenzo[d,f][1 ,3,2]dioxaphosphepin-6-yl]oxy]-N,N-bis[2-[[2,4,8,10-tetrakis(1,1-dimethylethyl)dibenzo[d,f] [1,3,2]dioxaphosphepin-6-yl]oxy]-ethyl]etamine is preferable.

Examples of sulfur-based antioxidation assistants include 2,2-thio-diethylenebis[3-(3,5-di-t-butyl-4-hydroxyphenyl) propionate], tetrakis[methylene-3-(dodecyltbio)propionate]methane, etc.

In addition to the aforesaid constituents, additives such as inorganic fillers, flame retardants, plasticizers, nucleation agents, dyes, pigments, mold separators, etc., can be added to the aromatic polyamide composition of the present invention.

### EXAMPLES

The present invention is explained below citing working examples, but the present invention is not limited to these working examples.

The constituent ingredients, constituent ratios, melting points, and glass transition temperatures of the semi-aromatic polyamides used in the working examples and comparative examples are shown in Table 1 and Table 5.

TABLE 1

| | A | B | C | D | E | F | G | H |
|---|---|---|---|---|---|---|---|---|
| Terephthalic | 34.1 | 38.5 | 43.1 | 32.2 | 22.5 | 32.8 | 22.9 | 50.0 |
| acid constituent | | | | | | | | |
| (mol %) | | | | | | | | |
| Isophthalic acid | 0 | 0 | 0 | 12.4 | 0 | 0 | 0 | 0 |
| constituent | | | | | | | | |
| (mol %) | | | | | | | | |
| Adipic acid | 15.9 | 11.5 | 6.9 | 5.4 | 27.5 | 17.2 | 27.1 | 0 |
| constituent | | | | | | | | |
| (mol %) | | | | | | | | |
| 12-aminodo- | 0 | 0 | 0 | 0 | 0 | 0 | 0 | 0 |
| decanoic acid | | | | | | | | |
| (mol %) | | | | | | | | |
| Hexamethylene | 42.7 | 37.7 | 32.7 | 50.0 | 50.0 | 37.9 | 45.2 | 25.0 |
| diamine | | | | | | | | |
| constituent | | | | | | | | |
| (mol %) | | | | | | | | |
| 2-methylpenta | 7.3 | 12.3 | 17.3 | 0 | 0 | 12.1 | 4.8 | 25.0 |
| methylene- | | | | | | | | |
| diamine | | | | | | | | |
| constituent | | | | | | | | |
| (mol %) | | | | | | | | |
| Melting point | 307 | 304 | 302 | 313 | 300 | 295 | 269 | 300 |
| (° C.) | | | | | | | | |
| Glass transition | 102 | 113 | 127 | 127 | 87 | 104 | 85 | 136 |
| temperature | | | | | | | | |
| (C. °) | | | | | | | | |

### Working Examples 1-7, Comparative Examples 1-5

The aromatic polyamides and impact resistance agents shown in Table 2 were melt-kneaded with a biaxial screw extruder (manufactured by W & P Corp., model ZSK-40), and after water-cooling were formed into pellets. Using the pellets obtained, test pieces of 3.2 mm×13 mm×130 mm were molded, and using the test pieces that were molded, the flexural elastic modulus was measured in accordance with ASTM D790-92. Additionally, test pieces were allowed to stand in an environment of 80° C. temperature and 95% humidity for 100 hours, and the flexural elastic modulus was measured. The results are shown in Table 2.

When Working Examples 1 and 2 and Comparative Examples 1 and 2 are compared, it can be seen that when a semi-aromatic polyamide in which the amount of aromatic monomer contain is lower than the specified content according to the present invention, and the glass transition temperature is also lower than that specified in the present invention, the flexural elastic modulus is dramatically lowered when exposed to high temperature and high humidity. Specifically, it is not possible to obtain the rigidity required in molded products having thin-wall parts.

TABLE 2

| | Working | Comparative | Comparative | Working |
|---|---|---|---|---|
| | Example 1 | Example 1 | Example 2 | Example 2 |
| Polyamide | F | G | E | B |
| Glass transition | 104 | 85 | 87 | 113 |
| temperature (° C.) | | | | |
| Melting point (° C.) | 295 | 269 | 300 | 304 |
| Impact resistance | b | b | a | b |
| agent | | | | |
| Amount of impact | 15 | 15 | 15 | 18 |
| resistance agent (%) | | | | |
| Flexural modulus | | | | |
| (kg/cm²) | | | | |
| Initial | 1931 | 1805 | 2276 | 1949 |
| After wetting* | 1734 | 689 | 873 | 2243 |
| Retention (%) | 90 | 38 | 38 | 115 |

*80° C. × 95% relative humidity × 100 hours

The impact resistance agents are as follows.

a: maleic anhydride graft-modified low-density polyethylene

b: maleic anhydride graft-modified elastomer (elastomer contains ethylene, propylene, octene, hexadiene constituents)

Additionally, the aromatic polyamides and impact resistance agents shown in Table 3 were melt-kneaded with a biaxial screw extruder (manufactured by W & P Corp., model ZSK-40), and after water-cooling were formed into pellets. Using the pellets obtained, test pieces having thicknesses of 1 mm and 3.2 mm were molded, and the lengths of the test pieces were measured. After placing the test pieces in a 160° C. oven for 24 hours, the lengths were again measured. When Working Example 3 and Comparative Example 3 are compared, it can be seen that, while there is no difference in the change in the dimensions resulting from the aforesaid treatment in the test pieces having a thickness of 3.2 mm, in the thin-wall test pieces of 1 mm in thickness, in Comparative Example 3, where a semi-aromatic polyamide having a higher glass transition temperature than that specified in the present invention was used, it can be seen that the dimensions changed markedly, and the thin-wall part was unsuitable for use as material for forming molded products.

TABLE 3

| | Working | Comparative |
|---|---|---|
| | Example 3 | Example 3 |
| Polyamide | B | H |
| Glass transition temperature (° C.) | 113 | 136 |
| Impact resistance agent | b | b |
| Impact resistance agents content (%) | 15 | 15 |
| 1 mm thick test piece length | | |
| initial (mm) | 114.37 | 114.37 |
| after annealing | 113.21 | 106.36 |
| change (%) | −1.0 | −7.0 |
| 3.2 mm thick test piece length | | |
| initial (mm) | 127.27 | 127.34 |
| after annealing | 125.98 | 126.11 |
| change (%) | −1.0 | −1.0 |

* 160° C. × 24 hours

The aromatic polyamides and impact resistance agents shown in Table 4 were melt-kneaded with a biaxial screw extruder (manufactured by W & P Corp., model ZSK-40), and after water-cooling were formed into pellets. Using the pellets obtained, connectors were formed, and their surface appearance was examined. While sink marks occurred on the molded product surface in Comparative Examples 4 and 5, Working Examples 4 through 7 had good appearance.

TABLE 4

| | Wkg | Wkg | Wkg | Wkg | Cmp | Cmp |
|---|---|---|---|---|---|---|
| | Ex 1 | Ex | Ex | Ex | Ex 4 | Ex 6 |
| Polyamide | A | A | B | B | C | D |
| Impact resistance agent | a | b | b | a | a | a |
| Impact resistance agents | 13 | 12 | 12 | 13 | 13 | 15 |
| content (wt %) | | | | | | |
| Surface appearance | □ | □ | □ | □ | X | X |

Surface appearance □: good X: unsatisfactory

### Working Examples 8-12, Comparative Examples 6-9

TABLE 5

| | J | K | L | M | P | Q | R |
|---|---|---|---|---|---|---|---|
| Tereplithalic acid | 34.1 | 36.3 | 38.5 | 43.1 | 32.2 | 25.9 | 22.5 |
| constituent (mol %) | | | | | | | |
| Isophthalic acid | 0 | 0 | 0 | 0 | 12.4 | 0 | 0 |
| constituent (mol %) | | | | | | | |
| Adipic acid constituent | 15.9 | 13.7 | 11.5 | 6.9 | 5.4 | 21.1 | 27.5 |
| (mol %) | | | | | | | |
| 12-aminododecanoic | 0 | 0 | 0 | 0 | 0 | 6.0 | 0 |
| acid (mol %) | | | | | | | |
| Hexamethylene | 42.7 | 40.2 | 37.7 | 32.7 | 50.0 | 47.0 | 50.0 |
| diamine constituent | | | | | | | |
| (mol %) | | | | | | | |
| 2-methylpenta | 7.3 | 9.8 | 12.3 | 17.3 | 0 | 0 | 0 |
| methylenediamine | | | | | | | |
| constituent (mol %) | | | | | | | |
| Melting point (° C.) | 307 | 305 | 304 | 302 | 313 | 298 | 300 |
| Glass transition | 102 | 108 | 113 | 127 | 127 | 82 | 87 |
| temperature (C. °) | | | | | | | |

The impact resistance agents are as follows.

a: maleic anhydride graft-modified low-density polyethylene

b: maleic anhydride graft-modified elastomer (elastomer contains ethylene, propylene, octene, hexadiene constituents)

The aromatic polyamides and impact resistance agents shown in Table 5 were melt-kneaded with a biaxial screw extruder (manufactured by W & P Corp., model ZSK-40), and after water-cooling were formed into pellets. Using the pellets obtained, test pieces of 3.2 mm×13 mm×130 mm were molded at a mold temperature of 80° C. Using the test pieces that were molded, the flexural elastic modulus was measured as described below. The results are shown in Table 6.

TABLE 6

| | Wkg | Wkg | Wkg | Wkg | Wkg | Cmp | Cmp | Cmp | Cmp |
|---|---|---|---|---|---|---|---|---|---|
| | Ex 8 | Ex 9 | Ex 10 | Ex 11 | Ex 12 | Ex 6 | Ex 7 | Ex 8 | Ex 9 |
| Polyamide | J | K | J | L | L | Q | M | P | R |
| Glass transition temperature of polyamide (° C.) | 102 | 108 | 102 | 113 | 113 | 82 | 127 | 127 | 87 |
| Impact resistance agent | a | a | b | b | a | a | a | a | a |
| Impact resistance agents content (wt %) | 13 | 13 | 12 | 12 | 13 | 15 | 13 | 15 | 15 |
| Surface appearance | □ | Note F | □ | □ | □ | Note 8 | X | X | Ø |
| Flexural modulus (Mpa) | | | Note C | Note D | Note E | | Note 2 | Note 3 | Note 4 |
| initial | 22600 | 22400 | | | | 19500 | | | |
| moisture absorbed | 21200 | 22900 | | | | 12000 | | | |
| Terminal holding power (N) | | Note A | | | | | | | |
| initial | 156 | | 151 | 154 | 157 | Note 1 | 154 | 152 | 135 |
| moisture absorbed | 142 | | 140 | 156 | 156 | | 156 | 146 | 87 |
| retention | 91 | | 92 | 101 | 98 | | 100 | 65 | 64 |
| High-temperature load deformation | Ø | Note B | Ø | □ | □ | Note 7 | X | Note 5 | Note 6 |

Surface appearance Ø: excellent □: good X: unsatisfactory
High-temperature load deformation Ø: equal to or less than 0.7 mm □: larger than 0.7 mm, equal to or less than 1 mm X: larger than 1 mm
Notes (1)-(8): Since at least one value among surface appearance, flexural modulus, terminal holding power, and high-temperature load deformation did not satisfy the requirements for an electrical connector for automobiles, measurement or observation was not performed with regard to the other characteristics.
Notes (A)-(F): Omitted except for purposes indicating improvement of characteristic properties of electrical connector for automobiles.

Flexural Modulus

Measured in accordance with ASTM D790-92; additionally, after test pieces were allowed to stand in an environment of 30 to 40° C. temperature and 95% humidity for 100 to 200 hours, the flexural elastic modulus was measured.

FIG. 1 shows the housing of a male-type electrical connector for automobiles using a composition the present invention, inside of which multiple housing chambers are partitioned and formed, and partition walls are formed on the upper and lower portions of each housing chamber.

Next, the housing of electrical connector for automobiles shown in FIG. 1 was formed using the pellets obtained and subjected to the following tests. The results are shown in Table 6.

Quality of Appearance

The surface of the molded product was visually evaluated.

Terminal Holding Power

FIG. 2 is a cross-sectional diagram showing the state in which a male-type contact terminal is housed and anchored inside the housing of a male-type electrical connector for automobiles. 2 shows a mechanism whereby an elastic piece on which a protrusion is formed and which is attached to the front face inside the housing is inserted and interlocked with a housed connecting terminal, and connecting terminal is held, and 3 shows the state in which a male-type connector and female-type connector are fitted together with elastic, flexible anchoring parts, and are mutually anchored.

A terminal wherein a wiring approximately 100 mm in length was pressure-bonded was anchored as shown in FIG. 2 in the electrical connector housing in an atmosphere of 23±2° C. temperature and 50±5% humidity, the wiring pulled in axial direction at a constant rate of approximately 100 mm/min, and the load at which the terminal was pulled out from the anchoring part 2 of the housing was made the initial terminal holding power. Also, the load was measured by the same test method using the electrical connector housing that was subjected to moisture absorption treatment, and this was made the terminal holding power when water was absorbed.

Terminal Holding Power Retention

The percentage of terminal holding power when water is absorbed versus the initial terminal holding power was made the terminal holding power retention.

High-Temperature Load Deformation

The male housing hood of electrical connector was subjected to a load of 50 grams in an atmosphere having a temperature of 23±2° C. and a humidity of 50±5%, and after standing for one-hour at 150° C., the load was removed, and the measured value of the amount deformation of the hood part after the test piece was allowed to stand in an atmosphere having a temperature of 23±2° C. and a humidity of 50±5% for 15 min was made the high-temperature load deformation.

When Working Examples 8 and 9 are compared with Comparative Example 6, it can be seen that when a semi-aromatic polyamide in which the aromatic monomer content is lower than the prescribed content on the glass transition temperature is also lower than prescribed in the present invention, the initial flexural modulus is low, and the flexural modulus drops even more markedly when moisture has been absorbed. Specifically, it was not possible to obtain the rigidity required in electrical connectors used in automobiles.

In comparison with Comparative Examples 7 and 8, where the glass transition temperature is higher than the range specified in the present invention, although Working Examples 8, 10, 11, and 12 have a retention of terminal holding power when water has been absorbed equal or slightly lower, they are sufficiently satisfactory as electrical connectors for automobiles and exhibit an improved high-temperature retention of terminal holding power when moisture has been absorbed. Additionally, in comparison with Comparative Example 9, in which the aromatic monomer content and glass transition temperature were lower than those specified in the present invention, Working Examples 8, 10, 11, and 12 were sufficiently satisfactory as electrical connectors for use in automobiles, although their surface appearance was slightly inferior, and also manifested improvement in retention of terminal holding power when absorbing water. Specifically, it can be seen that the electrical connectors for automobiles in accordance with the present invention have an excellent balance of characteristics as electrical connectors for automobiles.

As explained above, by means the present invention, is possible to offer a resin composition that is suitable as a material for molded products having thin-wall parts and for automotive electrical connectors, which are provided with high tenacity and have excellent rigidity in high-temperature, high-humidity environments and the surface appearance.

1. A polyamide composition for molded products having thin-wall parts, characterized as containing:
A. 100 wt parts of a semi-aromatic polyamide having a melting point of 280 to 320° C. and a glass transition temperature of 95 to 115° C., and wherein aromatic monomers constituting the polyamide make up at least 30 mol %, and
B. 1 to 70 wt parts of an impact resistance agent composed mainly of a modified polyolefin that has been graft-modified by means of a carboxylic acid or a carboxylic anhydride.

2. A polyamide composition for molded products having thin-wall parts, characterized as containing:
A. 100 wt parts of an aromatic polyamide having a melting point of 280 to 320° C. and glass transition temperature of 95 to 115° C., and wherein aromatic monomers constituting the polyamide make up at least 30 mol %, and the dicarboxylic acid constituent is selected from the group consisting of terephthalic acid, blends of terephthalic acid and isophthalic acid wherein the isophthalic acid in the dicarboxylic acid constituent is no more than 40 mol %, blends of terephthalic acid and adipic acid, and blends of terephthalic acid, isophthalic acid, and adipic acid, wherein the total amount of isophthalic acid and adipic acid in the dicarboxylic acid constituent is no greater than 40 mol %, and the diamine constituent is selected from the group consisting of hexamethylenediamine and blends of hexamethylenediamine and 2-methylpentamethylenediamine, and
B. 1 to 70 wt parts of an impact resistance agent composed mainly of a modified polyolefin that has been graft-modified by means of a carboxylic acid or a carboxylic anhydride.

3. The composition of claim 1 useful for molding electrical connectors.

4. The composition of claim 2 useful for molding electrical connectors.
